(19) United States
(12) Patent Application Publication
(10) Pub. No.: US 2008/0051246 A1
(43) Pub. Date: Feb. 28, 2008

(54) Multi-speed transmission

(75) Inventor: Gerhard Gumpoltsberger, Friedrichshafen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/705,113

(22) Filed: Feb. 9, 2007

(30) Foreign Application Priority Data
Feb. 14, 2006 (DE) 10 2006 006 650.2

(51) Int. Cl. F16H 3/66

(52) U.S. Cl. 475/276

(57) ABSTRACT

A multi-speed transmission with six forward gears and one reverse gear comprises an input shaft (1), an output shaft (2), three planetary gearsets (P1, P2, P3), six rotatable shafts (1, 2, 3, 4, 5, 6) as well as five shifting elements (03, 04, 14, 36, 46), wherein the input shaft (1) is connected to the sun gear of the planetary gearset (P2) and can be detachably connected via a clutch (14) to the shaft (4), which is connected to the carrier of the planetary gearset (P3), can be coupled to the housing (G) via the brake (04) and detachably coupled to the shaft (6) via the clutch (46), wherein the shaft (6) is connected to the sun gear of the planetary gearset (P2) and can be detachably coupled via a clutch (36) to the shaft (3), which is connected to the internal gear of the planetary gearset (P1), coupled to the sun gear of the planetary gearset (p3) and can be coupled via the brake (03) to the housing (G), wherein the shaft (5) is connected to the internal gear of the planetary gearset (P2) and the carrier of the planetary gearset (P1), and the output shaft (2) is connected to the internal gear of the planetary gearset (P3), wherein the sun gear of the planetary gearset (P1) is non-rotatably connected to the housing (G) via a shaft (0).

This application claims priority from German Application Serial No. 10 2006 006 650.2 filed Feb. 14, 2006.

### FIELD OF THE INVENTION

The present invention relates to a multistage transmission in planetary design, particularly an automatic transmission for a motor vehicle.

### BACKGROUND OF THE INVENTION

According to the state of the art, particularly for motor vehicles, automatic transmission comprise planetary gearsets, which are shifted using friction and/or shifting elements, such as clutches and brakes and which are typically connected to a starting element that is subject to a slip effect and optionally provided with a converter lock-up clutch, for example, a hydrodynamic torque converter or a fluid clutch.

A transmission of this type is described in EP 0 434 525 A1. It substantially comprises one input shaft and one output shaft, which are arranged parallel to each other; a double-ratio planetary gearset, concentric with the output shaft and five shifting elements in the form of three clutches and two brakes, the selective operation of which in pairs determines the different gear ratios between the input shaft and the output shaft. This transmission has an upstream-connected gearset and two power paths so that by the selective engagement in pairs of the five shifting elements, six forward gears are obtained.

In the first power path, two clutches are required for transmitting the torque from the upstream-connected gearset to two elements of the double-ratio planetary gearset. These elements are provided in the power flow direction substantially behind the upstream-connected gearset in the direction of the double-ratio planetary gearset. In the second power path, a further clutch is provided, which detachably connects this path with a further element of the double-ratio planetary gearset. The clutches are arranged such that the inner disk carrier forms the output.

Additionally, from the published prior art U.S. Pat. No. 6,139,463, a compact multi-speed transmission in planetary design, particularly for a motor vehicle, is known, which has two planetary gearsets and one upstream-connected gearset as well as three clutches and two brakes. In this known multi-speed transmission, two clutches C-1 and C-3 are provided in a first power path for transmitting the torque from the upstream-connected gearset to the two planetary gearsets. The outer disk carrier and/or the cylinder or piston and pressure compensation sides of the clutch C-3 are connected to a first brake B-1. In addition, the inner disk carrier of the third clutch C-3 is connected to the cylinder and/or piston and pressure compensation sides of the first clutch C-1, the inner disk carrier of the first clutch C-1 being arranged on the output side and connected to a sun gear of the third planetary gearset.

Furthermore, from DE 199 49 507 A1 by the Applicant, a multi-speed transmission is known, according to which on the drive shaft two non-shiftable, upstream-connected gearset are provided which, on the output side, generate two rotational speeds which, in addition to the rotational speed of the input shaft, can be selectively switched by engaging the shifting elements to a shiftable double planetary gearset acting upon the output shaft such that for changing from one gear to the next higher or lower gear of the two actuated shifting elements, only one shifting element must be engaged or disengaged.

DE 199 12 480 A1 discloses an automatically shiftable motor vehicle transmission with three single planetary gearsets as well as three brakes and two clutches for switching between six forward gears and one reverse gear and with one drive shaft and one output shaft. The automatically shiftable motor vehicle transmission is configured such that the drive shaft is directly connected to the sun gear of the second planetary gearset and that the drive shaft can be connected via the first clutch to the sun gear of the first planetary gearset and/or via the second clutch to the carrier of the first planetary gearset. Additionally or alternatively, the sun gear of the first planetary gearset can be connected via the first brake to the transmission housing and/or the carrier of the first planetary gearset can be connected via the second brake to the housing and/or to the sun gear of the third planetary gearset, via the third brake.

As well, DE 102 13 820 A1 discloses a multi-speed automatic transmission, comprising a first input path T1 of a first speed ratio; an input path T2, which has a larger speed ratio than the input path T1; a planetary gearset of four elements, wherein the four elements are a first element, a second element, a third element and a fourth element following an order of elements on a speed diagram; a clutch C-2 transmitting a rotation from the input path T2 to the first element S3; a clutch C-1 transmitting the rotation from the input path T2 to the fourth element S2; a clutch C-4 transmitting a rotation from the input path T1 to the first element; a clutch C-3 transmitting the rotation from the input path T1 to the second element C3; a brake B-1 engaging the fourth element; a brake B-2 engaging the second element, and an output member coupled with the third element R3.

Within the scope of DE 101 15 983 A1 by the Applicant, a multi-speed transmission is described, comprising a drive shaft that is linked with an upstream-connected gearset; an output shaft that is connected with a downstream-connected gearset, and a maximum of seven shifting elements through the selective shifting of which at least seven forward gears can be shifted without range shifting. The upstream-connected gearset is formed by an upstream-connected planetary gearset or a maximum of two non-shiftable upstream-connected planetary gearset linked with the first upstream-connected planetary gearset, wherein the downstream-connected gearset is configured as a two-carrier, four-shaft transmission with two shiftable downstream-connected planetary gearsets and has four free shafts. The first free shaft of this two-carrier, four-shaft transmission is connected with the first shifting element; the second free shaft with the second and third shifting elements; the third free shaft with the fourth and fifth shifting elements, and the fourth free shaft is connected with the output shaft. According to the invention, a multi-speed transmission with a total of six shifting elements is proposed, which connect the third free shaft or the first free shaft of the downstream-connected gearset additionally with a sixth shifting element. For a multi-speed transmission with a total of seven shifting elements, according to the invention, it is proposed that the third free shaft is additionally connected with a sixth shifting element D′ and the first free shaft additionally with a seventh shifting element.

Furthermore, a multi-stage reduction gear with at least seven gears is described within the framework of DE 101 15 987 of the Applicant. In addition to the input shaft and the output shaft, this transmission comprises a non-engageable upstream-connected gear and an engageable downstream-connected gear in the form of a two-carrier, four-shaft transmission. The upstream-connected gear comprises a first planetary gearset which, in addition to the input rotational speed of the input shaft, also provides a second rotational speed, which may optionally be shifted to the downstream-connected gear. The downstream-connected gear comprises two engageable planetary gearsets, which can enable at least seven gears using the six shift elements, forming two power paths. During each shifting operation, group shifting is advantageously avoided. Furthermore, a 9-gear multi-speed transmission is known from DE 29 36 969. It comprises eight shift elements and four wheel sets.

Automatic vehicle transmissions in planetary designs, in general, have previously been described in the state of the art on many occasions and undergo continuous developments and improvements. These transmissions should have, for example, a sufficient number of forward gears as well as one reverse gear and a gear ratio that is excellently suited for motor vehicles, having a high overall spread as well as favorable progressive ratios. Furthermore, they should allow a high starting gear ratio in the forward direction and include a direct gear and, additionally, are suited for use both in passenger cars and in commercial vehicles. In addition, these transmissions should have a low complexity, in particular require a small number of shifting elements, and avoid double-shifts when shifting sequentially, so that always only one shifting element is engaged when shifting in defined gear groups.

The present invention is based upon the objective of proposing a multi-speed transmission of the type mentioned above in which the construction expenditure is optimized and the efficiency in the main driving gears is improved with regard to drag and gearing losses. Furthermore, it is intended that low torque act on the shifting elements and planetary gearsets in the multi-speed transmission according to the invention, and that the rotational speeds of the shafts, shifting elements and planetary gearsets be kept as low as possible. In addition, the required number of gears and spread of the gear ratios are also supposed to be maintained, advantageously implementing six forward gears and at least one reverse gear. Also according to the invention, the transmission is supposed to be suitable for any design in a vehicle, particularly for a frontal-transverse configuration.

### SUMMARY OF THE INVENTION

According to the invention, a multi-speed transmission in planetary design is proposed, which has one input shaft and one output shaft, which are arranged in a housing. At least three planetary gearsets (hereinafter referred to as the first, second and third planetary gearsets), at least six rotatable shafts (hereinafter referred to as the input shaft, output shaft, third, fourth, fifth and sixth shafts) and at least five shifting elements, comprising brakes and clutches, are provided. The selective engagement of these components creates different gear ratios between the input shaft and the output shaft so that preferably six forward gears and one reverse gear can be shifted.

The output shaft is permanently connected to the sun gear of the second planetary gearset and can be detachably connected via a clutch to the fourth shaft, wherein the fourth shaft is permanently connected to the carrier of the third planetary gearset, can be coupled to the housing via a brake and can be detachably connected via another clutch to the sixth shaft.

According to the invention, the sixth shaft is permanently connected to the carrier of the second planetary gearset and can be detachably connected via a clutch to the third shaft, wherein the third shaft is permanently connected to the ring gear of the first planetary gearset and the sun gear of the third planetary gearset and can be coupled to the housing via a brake. The fifth shaft is permanently connected to the ring gear of the second planetary gearset and the carrier of the first planetary gearset.

The output shaft is permanently connected to the ring gear of the third planetary gearset, wherein the sun gear of the first planetary gearset is connected non-rotatably to the housing via a non-rotating shaft.

The configuration of the multi-speed transmission, according to the invention, produces suitable gear ratios particularly for passenger cars as well as a considerable increase of the total spread of ratios of the multi-speed transmission, resulting in improved driving comfort and a significant improvement in fuel economy.

In addition, the multi-speed transmission, according to the invention, allows a considerably decreased complexity to be achieved, due to the low number of shifting elements, preferably two brakes and three clutches. According to the invention, it is beneficially possible, with the multi-speed transmission, to start driving with a hydrodynamic converter, a hydrodynamic clutch, an external starting clutch or with other suitable external starting elements. It is also conceivable to have a starting operation with a starting element integrated in the transmission. A shifting element, actuated in the first gear and in the reverse gear, is preferred.

In addition, good efficiency in the main driving gears, with regard to drag and gearing losses, can be achieved with the multi-speed transmission according to the invention.

Furthermore, low torque is present in the shifting elements and in the planetary gearsets of the multi-speed transmission, thus beneficially reducing the wear on the multi-speed transmission. In addition, the low torque correspondingly makes small dimensions possible, allowing reductions in the required installation space and the corresponding expenses. In addition, the low rotational speeds are present in the shafts, shifting elements and planetary gearsets.

In addition, the transmission, according to the invention, is designed such that it can be adjusted to different drive train configurations, both in power flow direction and with regard to space.

### BRIEF DESCRIPTION OF THE DRAWINGS

The invention will now be described, by way of example, with reference to the accompanying drawings in which:

FIG. 1 is a schematic illustration of a preferred embodiment of a multi-speed transmission according to the invention;

FIG. 2 is an exemplary shifting pattern for the multi-speed transmission according to the invention from FIG. 1;

FIG. 3 is a diagrammatic view of an embodiment of the inventive mutli-speed transmission having a one-way clutch;

FIG. 4 is a diagrammatic view of an embodiment of the inventive mutli-speed transmission with ane electric machine;

FIG. 5 is a diagrammatic view of a preferred design of the inventive multi-speed transmission having a wear-free brake;

FIG. 6 is a diagrammatic view of a further embodiment of the invention with the input and the output being provided on the same side of the housing;

FIG. 7 is a diagrammatic view of another embodiment of the inventive multi-speed transmission with the crankshaft of the drive motor fixed to the input shaft of the multi-speed transmission and the driving element located behind the multi-speed transmission;

FIG. 8 is a diagrammatic view of an embodiment of the inventive multi-speed transmission having a differential;

FIG. 9 is a diagrammatic view of an embodiment of the inventive multi-speed transmission with a clutch element and a drive motor;

FIG. 10 is a diagrammatic view of an embodiment of the inventive multi-speed transmission with a crankshaft of the drive motor fixed to an input shaft of the multi-speed transmission;

FIG. 11 is a diagrammatic view of an embodiment of the inventive multi-speed transmission having the drive motor communicating with a damper; and

FIG. 12 is a diagrammatic view of an embodiment of the inventive multi-speed transmission with a power take-off for driving an additional unit.

### DETAILED DESCRIPTION OF THE INVENTION

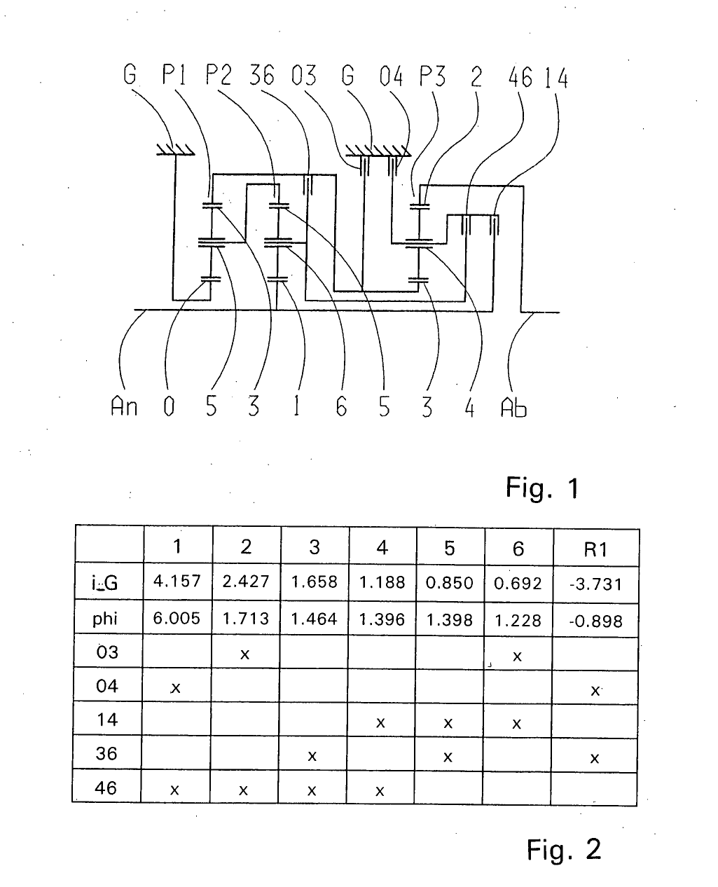

Accordingly, FIG. 1 shows a multi-speed transmission comprising an input shaft 1 (An) and an output shaft 2 (Ab), which are arranged in a housing G. Three planetary gearsets P1, P2, P3 are provided, which are preferably configured as negative planetary gearsets and arranged in the sequential order of P1, P2, P3 in the axial direction.

As can be seen from FIG. 1, only five shifting elements, namely two brakes 03, 04 and three clutches 14, 36, and 46, are provided. With selective engagement of these shifting elements, six forward gears and one reverse gear can be implemented. The multi-speed transmission according to the invention has a total of six rotatable shafts, namely the shafts 1, 2, 3, 4, 5 and 6.

According to FIG. 1, it is provided in the multi-speed transmission that the input occurs via the shaft 1, which is permanently connected to the sun gear of the second planetary gearset P2 and can be detachably connected via the clutch 14 to the shaft 4, wherein the shaft 4 is permanently connected to the carrier of the third planetary gearset P3, can be coupled to the housing G via the brake 04 and can be detachably coupled to the shaft 6 via the clutch 46.

In this connection, the shaft 6 is permanently connected to the carrier of the second planetary gearset P2 and can be detachably connected via the clutch 36 to the shaft 3, where the shaft 3 is permanently connected to the ring gear of the first planetary gearset P1 and the sun gear of the third planetary gearset P3 and can be coupled to the housing G via the brake 03. Furthermore, the shaft 5 is permanently connected to the ring gear of the second planetary gearset P2 and the planet carrier of the first planetary gearset P1.

The output occurs via the shaft 2, which is permanently connected to the ring gear of the third planetary gearset P3. Furthermore, the sun gear of the first planetary gearset P1 is non-rotatably connected to the housing G via a shaft 0.

Within the scope of the illustrated embodiments, the clutches 46 and 14 are arranged behind the third planetary gearset P3 in the sequence 46, 14 from an axial point of view in the power flow direction and as disk clutches may comprise a common outer disk carrier. The brakes 04, 03 are preferably arranged between the second and third planetary gearsets P2, P3 in the order 03, 04, also from an axial point of view in the power flow direction.

The spatial configuration of the shifting elements can be arbitrary and is only limited by the dimensions and the shape.

FIG. 2 shows a shifting pattern of the multi-speed transmission according to the invention from FIG. 1 by way of example. For each gear, two shifting elements are engaged. The shifting pattern shows a respective gear ratio i of the individual gear steps and a resulting progressive ratio phi by way of example. Typical stationary gear ratio values of the planetary gearsets P1, P2, P3 are −2.086, −2.506 and −2.249, respectively. The shifting pattern also shows that double-shifts and/or range shifts are avoided when shifting sequentially because two adjoining gear steps jointly use one shifting element.

The first gear is designed by engaging the brake 04 and the clutch 46, the second gear from engaging the brake 03 and the clutch 46, the third gear from engaging the clutches 36 and 46. The fourth gear is defined from engaging the clutch 14 and the clutch 46, the fifth gear from engaging the clutches 14 and 36, and the sixth gear from engaging the brake 03 and the clutch 14. As the shifting pattern shows, the reverse gear is defined from engaging the brake 04 and the clutch 36.

According to the invention, starting with an integrated shifting element 04, 46 is possible for which particularly the brake 04 is suited, which is required in the first gear and the reverse gear. Furthermore, depending on the shifting logic, different gear steps may be obtained from the same gear pattern, allowing application- and/or vehicle-specific variations.

In addition, it is possible, as shown in FIG. 3, to provide a one-way clutch 38 at a suitable location(s) within the multi-speed transmission, for example, between a shaft and the housing or to optionally connect two shafts.

An axle differential and/or a distributor differential 20 may be arranged on the input side or the output side according to the invention, as shown in FIG. 8.

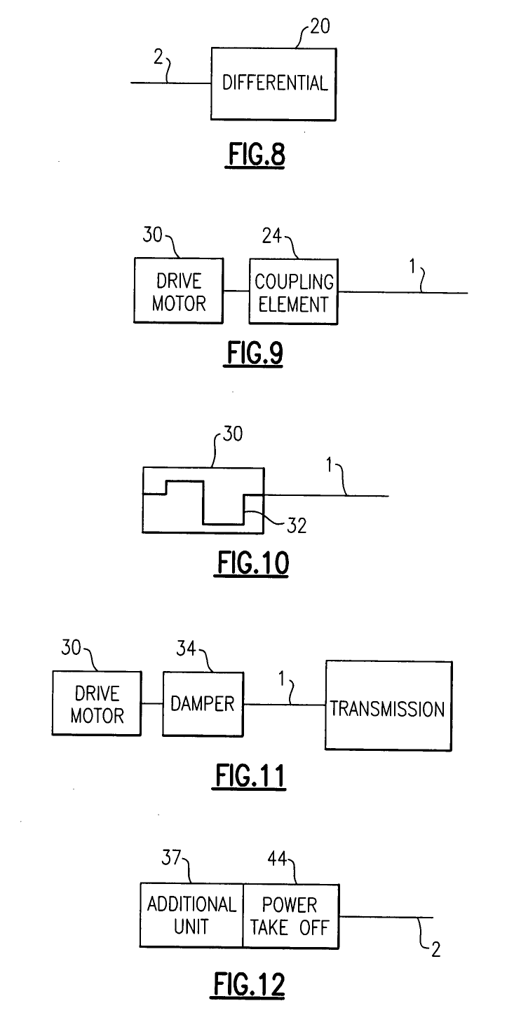

Within the scope of a further advantageous embodiment, shown in FIG. 9, the input shaft 1 may be separated from the drive motor 30, as needed, by a coupling element 24 where the coupling element may be a hydrodynamic converter; a hydraulic clutch; a dry starting clutch; a wet starting clutch; a magnetic powder clutch or a centrifugal clutch. It is also possible to provide, as shown in FIG. 7, such a driving element 25 in the power flow direction behind the transmission where, in this case, as also shown in FIG. 10, the input shaft 1 is permanently connected to the crankshaft 32 of the drive motor 30.

The multi-speed transmission, according to the invention, as shown in FIG. 11, also permits arranging a torsional vibration damper 34 between the engine (drive motor) 30 and transmission.

Within the scope of a further embodiment of the invention, as shown in FIG. 5, a wear-free brake 42, such as a hydraulic retarder or electric retarder or the like, may be arranged on the input shaft 1 or the output shaft 2, which is particularly important when the transmission is used in commercial vehicles. Furthermore, as shown in FIG. 12, a power take-off 44 may be provided on each shaft, preferably on the input shaft 1 or the output shaft 2, to drive an additional unit(s) 37. Additionally, as shown in FIG. 6, the input and output shafts are provided on the same side of the housing.

The shifting elements used may be configured as power-shift clutches or brakes. In particular, power-shift clutches or brakes, such as multi-disk clutches, band brakes and/or cone clutches, may be used. Furthermore, it is also possible to use positive brakes and/or clutches, such as synchronization devices or claw clutches, as the shifting elements.

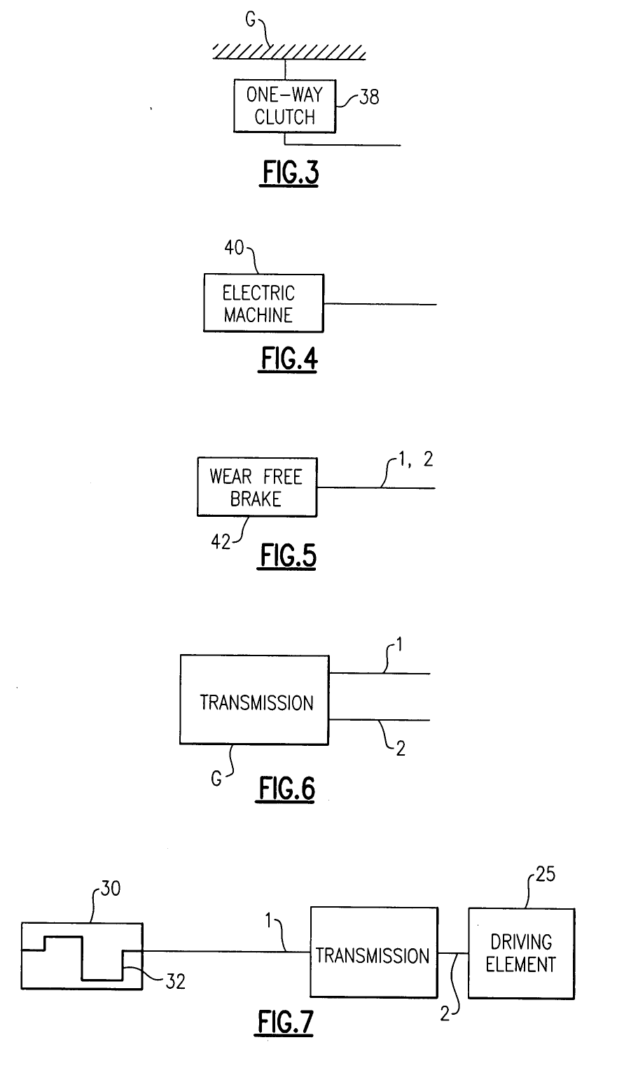

A further advantage of the multi-speed transmission presented here and shown in FIG. 4, is that an electric machine 40 can be provided on each shaft as a generator and/or as an additional drive unit.

Of course, any design configuration, particularly any spatial configuration of the planetary gearsets and the shifting elements as such, as well as in relation to each other to the extent they are technically expedient, falls under the scope of protection of the present claims, without influencing the function of the transmission as described in the claims, even if these embodiments are not explicitly illustrated in the Figures or mentioned in the description.

### REFERENCE NUMERALS

0 shaft 36 clutch
1 shaft 37 additional unit
2 shaft 38 one-way clutch
3 shaft 40 electric machine
4 shaft 42 wear-gree rake
5 shaft 44 power-take off
6 shaft 46 clutch
03 brake
04 brake P1 planetary gearset
14 clutch P2 planetary gearset
20 differential P3 planetary gearset
24 coupling element An input
25 driving element Ab output
30 drive motor i gear ratio
32 crank shaft phi progressive ratio
34 damper G housing

1-24. (canceled)

25. An automatic multi-speed transmission of a planetary design for a motor vehicle, the transmission comprising:
an input shaft (1) and an output shaft (2) arranged in a housing (G);
first, second and third planetary gearsets (P1, P2, P3);
at least third, fourth, fifth and sixth rotatable shafts (3, 4, 5, 6); and
at least five shifting elements (03, 04, 14, 36, 46) comprising first and second brakes (03, 04) and first, second and third clutches (14, 36,46) whose selective engagement creates different gear ratios between the input shaft (1) and the output shaft (2) such that at least six forward gears and one reverse gear are implemented;
the input shaft (1) is fixed to a sun gear of the second planetary gearset (P2) and is detachably coupled, via the first clutch (14), to the fourth shaft (4);
the fourth shaft (4) is fixed to a carrier of the third planetary gearset (P3) and is detachably coupled, via the second brake (04), to the housing (G) and is detachably coupled, via the third clutch (46), to the sixth shaft (6);
the sixth shaft (6) is fixed to a carrier of the second planetary gearset (P2) and is detachably coupled, via the second clutch (36), to the third shaft (3);
the third shaft (3) is fixed to a ring gear of the first planetary gearset (P1) and a sun gear of the third planetary gearset (P3) and is detachably coupled, via the first brake (03), to the housing (G);
the fifth shaft (5) is fixed to a ring gear of the second planetary gearset (P2) and a carrier of the first planetary gearset (P1);
the output shaft (2) is fixed to a ring gear of the third planetary gearset (P3); and
a sun gear of the first planetary gearset (P1) is fixed, via a seventh shaft (0), to the housing (G).

26. The multi-speed transmission according to claim 25, wherein the first, the second and the third planetary gear sets (P1, P2, P3) are arranged in an axial direction in the following sequential order:
the first planetary gear set (P1), the second planetary gear set (P2) and the third planetary gear set (P3).

27. The multi-speed transmission according to claim 25, wherein the first, the second and the third planetary gearsets (P1, P2, P3) are negative planetary gearsets.

28. The multi-speed transmission according to claim 24, wherein from an axial point of view, the third and the first clutches (46,14) are sequentially arranged behind the third planetary gearset (P3), in a direction of power flow, in an order of the third clutch (46) and then the first clutch (14).

29. The multi-speed transmission according to claim 25, wherein the third and the first clutches (46, 14) are multi-disk clutches which have a common outer disk carrier.

30. The multi-speed transmission according to claim 25, wherein the first and the second brakes (03, 04) are axially arranged between the second and the third planetary gearsets (P2, P3), in a power flow direction, in a sequential order of the first brake (03) and then the second brake (04).

31. The multi-speed transmission according to claim 25, wherein first gear results by engagement of the second brake (04) and the third clutch (46), second gear results by engagement of the first brake (03) and the third clutch (46), third gear results by engagement of the second and the third clutches (36, 46), fourth gear results by engagement of the first clutch (14) and the third clutch (46), fifth gear results by engagement of the first and the second clutches (14, 36), and sixth gear results by engagement of the first brake (03) and the first clutch (14).

32. The multi-speed transmission according to claim 25, wherein the reverse gear results by engagement of the second brake (04) and the second clutch (36).

33. The multi-speed transmission according to claim 25, wherein a one-way clutch is coupled to at least one of the input shaft (1), the output shaft (2), the third shaft (3), the fourth shaft (4), the fifth shaft (5) and the sixth shaft (6).

34. The multi-speed transmission according to claim 25, wherein a one-way clutch is located between at least one of the input shaft (1), the output shaft (2), the third shaft (3), the fourth shaft (4), the fifth shaft (5) and the sixth shaft (6) and the housing (G).

35. The multi-speed transmission according to claim 25, wherein the input shaft (1) and the output shaft (2) are both located on a common side of the housing (G).

36. The multi-speed transmission according to claim 25, wherein one of an axle differential and a distributor differential is located on one of the input shaft (1) and the output shaft (2).

37. The multistage transmission according to claim 25, wherein the input shaft (1) is separated from a drive motor by a coupling element.

38. The multi-speed transmission according to claim 37, wherein the coupling element is one of a hydrodynamic converter, a hydraulic clutch, a dry starting clutch, a wet starting clutch, a magnetic powder clutch and a centrifugal clutch.

39. The multi-speed transmission according to claim 25, wherein an external driving element is arranged, in a direction of power flow, behind the transmission and the input shaft (1) is fixed to a crankshaft of a drive motor.

40. The multi-speed transmission according to claim 25, wherein at least one of the five shifting elements (04, 46) of the multi-speed transmission initiates starting and the input shaft (1) is fixed to a crankshaft of a drive motor.

41. The multi-speed transmission according to claim 25, wherein a torsional vibration damper is located between the transmission and a drive motor.

42. The multi-speed transmission according to claim 25, wherein a wear-free brake is located on at least one of the input shaft (1), the output shaft (2), the third shaft (3), the fourth shaft (4), the fifth shaft (5) and the sixth shaft (6).

43. The multi-speed transmission according to claim 25, wherein a power take-off is located on at least one of the input shaft (1), the output shaft (2), the third shaft (3), the fourth shaft (4), the fifth shaft (5) and the sixth shaft (6) for driving an additional unit.

44. The multi-speed transmission according to claim 43, wherein the power takeoff is located on one of the input shaft (1) and the output shaft (2).

45. The multi-speed transmission according to claim 25, wherein each of the at least five shifting elements (03, 04, 14, 36, 46) is one of a power-shift clutch and an additional brake.

46. The multi-speed transmission according to claim 45, wherein the power-shift clutches and the additional brakes are one of a multi-disk clutch, a band brake and a cone clutch.

47. The multi-speed transmission according to claim 25, wherein each of the at least five shifting elements (03, 04,14, 36, 46) is one of a positive clutch or a further brake.

48. The multi-speed transmission according to claim 25, wherein an electric machine is located on at least one of the input shaft (1), the output shaft (2), the third shaft (3), the fourth shaft (4), the fifth shaft (5) and the sixth shaft (6).
